(19) United States
(12) Patent Application Publication
(10) Pub. No.: US 2008/0217320 A1
(43) Pub. Date: Sep. 11, 2008

(54) Cooking Appliance with Touch-Sensitive Control Strip

(75) Inventors: Thomas Meindl, Kirchanschoring (DE); Peter Schuhbaeck, Otting (DE); Ernst Wurnitsch, Kirchdorf in Tirol (AT)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 11/990,719

(22) PCT Filed: Jul. 31, 2006
(86) PCT No.: PCT/EP2006/064864

§ 371 Date: Feb. 19, 2008

(30) Foreign Application Priority Data
Aug. 25, 2005 (DE) 10 2005 040 346.8

(51) Int. Cl. F24C 7/08; F24C 15/00; A47J 37/00; H05B 1/02

(52) U.S. Cl. 219/491; 126/1 R; 99/333

(57) ABSTRACT

A cooking appliance having a control strip, constituted of a series of touch-sensitive sensors, are known for adjusting variables for a parameter of an item to be cooked, such as e.g. for the cooking time or the heating capacity levels. An adjustable variable is adjusted from a series of stored adjustable variables depending on the longitudinal position of a finger of a user guided on the control strip. In order to simplify operation of the control strip, the control strip, in at least one main mode of operation, is associated with a subsection of the series of adjustable variables from the entire series of adjustable variables.

The invention relates to a cooking appliance according to the preamble of patent claim 1.

Such a control unit is known for a cooking appliance from EP 1 273 851 A2. The multitude of modes in the prior art also includes a zoom function, that is the selection of a section from the adjustment curve, and the assignment of this adjustment curve and the assignment of this section to the entire control strip. In EP 1 273 851 A2, the zoom function only becomes available if the control strip is touched for 10 seconds, where after 5 seconds transition of the control strip functions takes place which has nothing to do with a zoom.

According to the prior art the functionality of the control strip is thus awkward.

The object of the invention is to make available a cooking appliance with a user-friendly control strip.

The object is solved by a cooking appliance with the features in claim 1.

According to the invention, a subsection of an adjustment curve or a stored series of adjustable variables can be assignable to the entire control strip of the cooking appliance in a main mode present at the start of operation.

Preferably, the entire adjustment curve or the stored series of adjustable variables can be assignable to the control strip through activation of a supplementary mode.

With the invention it becomes possible to make an entire adjustment curve available to the operator, but to transfer out to the supplementary mode infrequently used subsections of the adjustment curve, whereby a particular subsection from an adjustment curve can be assigned in the main mode in optimal fashion.

For example the adjustment curve can represent a cooking time, while the main mode present at the start of operation is restricted in a subsection of the adjustment curve to typical cooking times. The adjustment curve can also represent a cooking temperature, and the subsection of the adjustment curve can then make available typical cooking temperatures.

The invention is based on the finding that in the prior art the control strip has resulted in totally superfluous value ranges for the various adjustment curves having been made available in the different modes, and that awkward operating actions were required to set typical values. The provision of typical values in a main mode available at the outset increases the user friendliness of the entire system.

In a preferred embodiment the main mode is enhanced in that there is no need to switch from the supplementary mode to the main mode, and that transition from the supplementary mode back to the main mode instead takes place automatically. This can happen after the elapsing of a specific period such as, for instance 5 seconds to 2 minutes, preferably around 10 seconds to 15 seconds. A typical duration for the switchover is 15 to 20 seconds.

In a preferable embodiment, at least in the main mode a multiplicity of mutually adjacent adjustment sections are assigned in each case groupwise to the same value from the adjustment curve. This does not then really involve a zoom section from the adjustment curve, that is a magnification of a section from the adjustment curve, because a magnification would bring with it the provision of intermediate values which are otherwise not available. The omission of these intermediate values and the selection of a limited number of values, which are assigned to the total number of adjustment sections in turn enables a restriction to typical adjustment values and enhances user friendliness in that the operator does not have available for selection totally superfluous intermediate values which are under certain circumstances indicated digitally on a display.

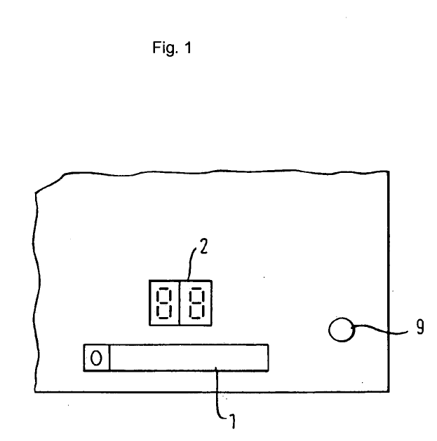

A preferable embodiment of the invention is now described with reference to the drawing, which in FIG. 1 shows a control strip with an assignment of adjustment sections and field units.

The invention is described below on the basis of the drawing, where:

FIG. 1 shows a top view of a section of an electric cooktop;

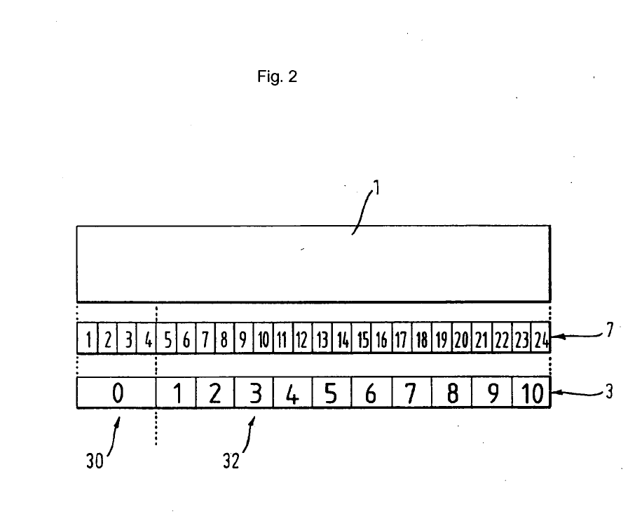

FIG. 2 shows a diagrammatic view of the control strip 1 with assigned adjustment sections and adjustable variables;

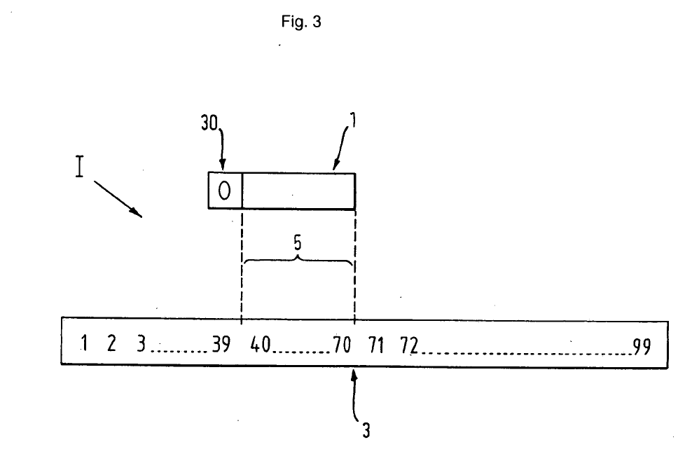

FIG. 3 shows a diagrammatic view of an assignment of the control strip 1 to adjustable variables in a main operating mode I, and

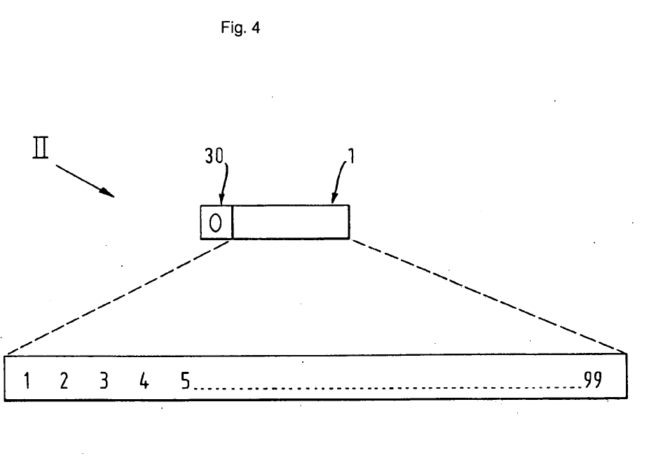

FIG. 4 shows a diagrammatic view of an assignment of the control strip 1 to adjustable variables in a subsidiary operating mode II.

FIG. 1 shows a top view of a section of an electric cooktop with a control strip 1 to which is assigned a double, seven-segment indicator 2. The control strip 1 of the cooktop serves to set adjustable variables from a series of such adjustable variables 3, as shown in FIGS. 2 to 4, and stored in the control electronics. According to FIG. 2, heating capacity levels of cooking zones of the cooktop can be set as adjustable variables from a level 1 to a level 10 from the series of adjustable variables 3. According to the FIGS. 3 and 4, cooking periods in minutes between 0 and 99 can be selected from the series of adjustable variables 3. A transition from the heating capacity setting to the cooking period setting can here be effected by actuation of a timer actuation switch according to FIG. 1.

The touch-sensitive control strip 1 has a multiplicity of touch-sensitive subsidiary surfaces or adjustment sections 7. These subsidiary surfaces (adjustment sections 7) can be assigned to adjustable variables of an adjustment curve or series of adjustable variables 3.

According to the FIGS. 3 and 4, adjustment of the cooking duration is activated by means of the timer switch 9 (FIG. 1). In FIG. 3, according to a main operating mode I set ex works, rather than the entire series of adjustable variables from 0 to 99 minutes, as stored in the control electronics, being assigned to the control strip, only a subsection 5 from the series of adjustable variables 3 is so assigned. According to FIG. 3, the subsection 5 covers the values of 40 minutes to 70 minutes customary for cooking purposes. A further reduction of the adjustable variable “40 minutes” takes place through movement of the finger from the second adjustment section 32 in the direction of the first adjustment section 30.

In FIG. 4, on the other hand, a subsidiary operating mode II is activated. According to the subsidiary operating mode II, all time specifications between 0 and 99 minutes which can be represented in the double seven-segment display 2 are assigned to the control strip 1.

In FIG. 2, the control strip 1 has the adjustment sections 7 arranged in series. Here, an adjustable variable from the series of adjustable variables (3) is in each case assigned to a multiplicity of adjacent adjustment sections 7. Heating capacity level 1 is, for example, assigned to the adjustment sections “5” and “6”.

The adjustment sections are divided into a first adjustment section 30 and a second adjustment section 32 arranged peripherally in the control strip 1. Upon actuation of the first adjustment section 30, an adjustable variable is set to 0. Upon actuation of the second adjusting section 32, an adjustable variable is set to a value greater than 0. Independently of the activation of the subsidiary operating mode II or the main operating mode I, an adjustable variable of 0 is assigned to the first adjusting section 30.

1-13. (canceled)

14. A cooking appliance with a touch-sensitive control strip for the setting of adjustable variables for a parameter of an item to be cooked, such as, for example, a cooking time or a heating capacity level, where, depending on the longitudinal position of a finger of a user drawn over the control strip, an adjustable variable from a series of stored adjustable variables is set, the cooking appliance comprising, at least in a main operating mode, a subsection of the entire series of adjustable variables is assigned to the control strip.

15. A cooking appliance comprising:
a. a heating apparatus;
b. a control system for controlling cooking operation of the heating apparatus; and
c. a user-operative control device in operational communication with the control system for the user-controlled setting of adjustable variables for at least one cooking parameter including at least one of a cooking time and a heating capacity level, with the control device being configured for selectively accessing an adjustable variable from a series of stored adjustable variables, wherein at least in a main operating mode, a subsection of the entire series of adjustable variables is accessible by the control device.

16. The cooking appliance according to claim 14 wherein the control device includes a touch-sensitive strip operable by a user moving a finger over a predetermined section of the strip.

17. The cooking appliance according to claim 14 wherein the control device is configured for operation in a subsidiary operating mode wherein the group of variables accessible by the control device is extended from the subsection of the entire series of adjustable variables to the entire series of adjustable values.

18. The cooking appliance according to claims 14 wherein at least in an operating mode of the cooking appliance the subsection of the series of adjustable variables is accessible by the control device.

19. The cooking appliance according to claim 14 wherein the control device includes a plurality of adjusting sections arranged in series.

20. The cooking appliance according to claim 18 wherein the control device is configured in a manner whereby one adjustable variable is assigned to every adjustment section.

21. The cooking appliance according to claim 18 wherein the control device is configured in a manner whereby at least one adjustable variable from the series of adjustable variables is assigned to a plurality of adjacent adjustment sections.

22. The cooking appliance according to claim 14 wherein the control device includes least a first adjustment section for setting an adjustable variable to 0 (zero) upon actuation of the control device.

23. The cooking appliance according to claim 21 wherein the control device includes second adjustment sections for setting adjustable variables greater than 0 (zero).

24. The cooking appliance according to claim 21 wherein the control device includes an adjustable variable of 0 (zero) assigned to the first adjustment section independently of the activation of the main operating mode or the subsidiary operating mode.

25. The cooking appliance according to claim 21 wherein the control device is configured as a control strip with the first adjustment section arranged adjacent the periphery of the control strip.

26. The cooking appliance according to claim 21 wherein the control device is configured in a manner wherein the second adjustment section adjacent the first adjustment section includes a minimum value of the series of adjustable variables.

27. The cooking appliance according to claim 25 wherein the control device includes a touch sensitive strip operable by a user moving a finger over a predetermined section of the strip.

28. The cooking appliance according to claim 25 wherein the control device is configured in a manner wherein a reduction of the minimum value takes place by a finger being drawn from the second adjustment section in the direction of the first adjustment section.

29. A method for operating a cooking appliance comprising the steps of:
a. providing a cooking apparatus; a control system for controlling cooking operation of the cooking apparatus; and a user-operative touch-sensitive control device in operational communication with the control system; and
b. controlling the cooking apparatus in a manner whereby the user sets adjustable variables for at least one cooking parameter including at least one of a cooking time and a heating capacity level, with the control device being configured for selectively accessing an adjustable variable from a series of stored adjustable variables, wherein at least in a main operating mode, a subsection of the entire series of adjustable variables is accessible by the control device.
